(19) United States
(12) Patent Application Publication
(10) Pub. No.: US 2025/0167972 A1
(43) Pub. Date: May 22, 2025

(54) SYSTEMS AND METHODS FOR TDD CONFIGURATION FOR SMART NODES

(71) Applicant: ZTE CORPORATION, Shenzhen, Guangdong (CN)

(72) Inventors: Hanqing XU, Shenzhen (CN); Nan ZHANG, Shenzhen (CN); Ziyang LI, Shenzhen (CN); Wei CAO, Shenzhen (CN)

(73) Assignee: ZTE CORPORATION, Shenzhen, Guangdong (CN)

(21) Appl. No.: 19/033,969

(22) Filed: Jan. 22, 2025

Related U.S. Application Data
(63) Continuation of application No. PCT/CN2022/112875, filed on Aug. 16, 2022.

(51) Int. Cl. H04L 5/14; H04W 72/0453; H04W 72/23

(52) U.S. Cl. CPC H04L 5/14; H04W 72/0453; H04W 72/23

(57) ABSTRACT

Presented are systems and methods for time division duplex (TDD) configuration for smart nodes (SNs). A network node can receive one or more messages from a wireless communication node. The one or more messages can indicate a first set of TDD configuration parameters and a second set of TDD configuration parameters. The first set of TDD configuration parameters can be configured for a first link. The second set of TDD configuration parameters can be configured for a second link.

### CROSS-REFERENCE TO RELATED APPLICATION

This application claims the benefit of priority under 35 U.S.C. § 120 as a continuation of PCT Patent Application No. PCT/CN2022/112875, filed on Aug. 16, 2022, the disclosure of which is incorporated herein by reference in its entirety.

### TECHNICAL FIELD

The disclosure relates generally to wireless communications, including but not limited to systems and methods for time division duplex (TDD) configuration for smart nodes (SNs).

### BACKGROUND

Coverage is a fundamental aspect of cellular network deployments. Mobile operators rely on different types of network nodes to offer blanket coverage in their deployments. As a result, new types of network nodes have been considered to increase the flexibility of mobile operators for their network deployments. For example, certain systems or architecture introduce integrated access and backhaul (IAB), which may be enhanced in certain other systems, as a new type of network node not requiring a wired backhaul. Another type of network node is the RF repeater which simply amplify-and-forward any signal that they receive. RF repeaters have seen a wide range of deployments in 2G, 3G and 4G to supplement the coverage provided by regular full-stack cells.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A network node (e.g., smart node (SN)) can receive one or more messages from a wireless communication node (e.g., base station (BS) or gNB). The one or more messages can indicate a first set of Time Division Duplex (TDD) configuration parameters and a second set of TDD configuration parameters. The first set of TDD configuration parameters may be configured for a first link. The second set of TDD configuration parameters may be configured for a second link.

In some arrangements, the first link can comprise at least one of following links: a first communication link from the wireless communication node to the network node; or a second communication link from the network node to the wireless communication node. In various arrangements, the second link can comprise at least one of following links: a first forwarding link from the wireless communication node to the network node; a second forwarding link from the network node to the wireless communication node; a third forwarding link from the network node to a wireless communication device; or a fourth forwarding link from the wireless communication device to the network node.

In some arrangements, the first link can work in or may be configured with a first frequency band or carrier. The second link can work in or may be configured with a second frequency band or carrier. In some arrangements, the network node can include a first unit and a second unit. In response to the first unit receiving the first set of TDD configuration parameters, the first unit can control reception and/or transmission over the first link. In response to the first unit receiving the second set of TDD configuration parameters, the second unit can perform reception and/or transmission over the second link, or the first unit can forward the second set of TDD configuration parameters to the second unit to allow the second unit to control reception and/or transmission over the second link.

In some arrangements, if the first link and the second link are configured with different TDD patterns or different directions in a symbol/slot: the network node can perform transmission or reception over the first link, and stop forwarding over the second link; the network node can perform forwarding over the second link, and stop transmission or reception over the first link; the network node can perform uplink operation and stop downlink operation; or the network node can perform downlink operation and stop UL operation. A high priority link or direction may be configured by the wireless communication node or an Operations, Administration, and Maintenance (OAM) node to the network node through system information, RRC signaling, MAC CE, or DCI.

In some arrangements, the first set of TDD configuration parameters can include a first parameter that is commonly, cell-specifically, or semi-statically configured for controlling reception and/or transmission over the first link. In various arrangements, the second set of TDD configuration parameters may include a second parameter that is commonly, cell-specifically, or semi-statically configured for controlling reception and/or transmission over the second link.

In some arrangements, the first set of TDD configuration parameters can include a third parameter that is equipment-dedicatedly, equipment-specifically or semi-statically configured for controlling reception and/or transmission over the first link. In various implementations, the second set of TDD configuration parameters may include a fourth parameter that is equipment-dedicatedly, equipment-specifically or semi-statically configured for controlling reception and/or transmission over the second link.

In some arrangements, the one or more messages can each be a Radio Resource Control (RRC) signaling or System Information (SI). The first set of TDD configuration parameters can include a fifth parameter that is a Medium Access Control Control Element (MAC CE), or a DCI. In some implementations, the second set of TDD configuration parameters can include a sixth parameter that is a MAC CE, or a DCI.

At least one aspect is directed to a system, method, apparatus, or a computer-readable medium. A network node (e.g., SN) can receive one or more messages from a wireless communication node (e.g., BS or gNB). The one or more messages can indicate a single set of Time Division Duplex (TDD) configuration parameters. The single set of TDD configuration parameters may be configured for a first link and implicitly for a second link.

In some arrangements, the first link can comprise at least one of following links: a first communication link from the wireless communication node to the network node; or a second communication link from the network node to the wireless communication node. In some implementations, the second link comprises at least one of following links: a first forwarding link from the wireless communication node to the network node; a second forwarding link from the network node to the wireless communication node; third forwarding link from the network node to a wireless communication device; or a fourth forwarding link from the wireless communication device to the network node.

In some arrangements, the network node can include a first unit and a second unit. In response to the first unit receiving the single set of TDD configuration parameters, the first unit can control reception and/or transmission over the first link; and/or in response to the first unit receiving a subcarrier spacing associated with the second unit, the first unit can determine, based on the subcarrier spacing, a set of TDD configuration parameters configured to control reception and/or transmission over the second link.

The systems and methods presented herein include a novel approach for time division duplex (TDD) configuration for SNs. Specifically, the systems and methods presented herein discuss a novel solution for indicating/providing/signaling (e.g., by the BS) one or more sets (e.g., two sets) of TDD uplink (UL) and/or downlink (DL) configuration (e.g., UL, DL, and/or flexible symbols/slots) parameters to the SN (e.g., SN CU), such as using one set of TDD configuration for SN CU transmission and/or reception, and another set of TDD configuration for SN FU transmission and/or reception (e.g., using the other set of TDD configuration for SN CU to control SN FU). SN FU and SN CU can work in the same or different frequency bands/carriers. Hence, the systems and methods of the technical solution can introduce the configuration parameters for TDD to enhance/improve/increase accuracy in controlling forwarding signals (e.g., among other signals) of the SN to at least one of the BS or the user equipment (UE), thereby improving flexibility of the SN in network deployment.

For instance, the first set of TDD UL/DL configuration parameter(s) can be used/implemented/configured for SN CU to SN CU including at least one of first, third, and/or fifth TDD UL/DL configuration parameters (e.g., as discussed herein). The second set of TDD UL/DL configuration parameters may be configured for SN FU to SN CU including at least one of second, fourth, and/or sixth TDD UL/DL configuration parameters.

In various arrangements, the first parameter(s) (e.g., TDD UL/DL configuration parameters) can be semi-statically configured (e.g., via system information and/or RRC signaling) and/or can be common or cell-specific (e.g., for SN CUs and/or UEs in a cell with a first frequency band/carrier). For example, as part of the first parameter(s), the parameter “tdd-UL-DL-ConfigurationCommon”in SIB1 and/or ServingCellConfigCommon can be used for indicating TDD UL/DL configuration used for SN CU to SN CU.

In various implementations, the second parameter(s) can be semi-statically configured (e.g., via system information and/or RRC signaling) and/or may be common or cell-specific (e.g., for SN FU and/or UE(s) in a cell with a second frequency band/carrier). For example, as part of the second parameter(s), a new parameter can be defined/described (e.g., in SIB1 and/or ServingCellConfigCommon) to be used for indicating TDD UL/DL configuration used for SN FU to SN CU. For instance, the new parameter can include, but is not limited to “tdd-UL-DL-ConfigurationCommon-SN-FU” in SIB1 and/or ServingCellConfigCommon, among others. The (e.g., reference) subcarrier spacing in the second parameter(s) can be limited, in certain cases. For TDD UL/DL configuration for SN FU indicated by the new parameter to SN CU in the first frequency band/carrier (e.g., SN CU working frequency band/carrier, such as in FR1 frequency band), this TDD UL/DL configuration may correspond to or be similar to TDD UL/DL configuration of BS indicating to one or more UEs in second frequency band/carrier (e.g., SN FU working frequency band/carrier, such as in FR2 frequency band).

In some arrangements, the third parameter(s) can be semi-statically configured (e.g., via RRC signaling) and/or may be dedicated (e.g., equipment-dedicated, link-dedicated, SN-dedicated, etc.) or UE-specific (e.g., equipment-specific), such as for controlling reception and/or transmission of a particular link. For instance, as part of the third parameters, a parameter “tdd-UL-DL-ConfigurationDedicated” in ServingCellConfig can be used for SN CU to SN CU (e.g., first link).

In various aspects, the fourth parameter(s) can be semi-statically configured (e.g., via RRC signaling) and/or may be dedicated or UE-specific. For example, as part of the fourth parameters, a new parameter can be defined (e.g., in ServingCellConfig, used in indicating TDD UL/DL configuration), such as used for SN FU to SN CU. For instance, a new parameter “tdd-UL-DL-ConfigurationDediated-SN-FU” in ServingCellConfig may be defined, in some cases.

In some cases, the new parameter (e.g., tdd-UL-DL-ConfigurationDedicated-SN-FU) can be assigned by TDD-UL-DL-ConfigDedicated. The TDD-UL-DL-ConfigDedicated can be similar to the current defined parameter in the specification and/or an enhanced parameter at least including subcarrier spacing, for example. In certain cases, the new parameter (e.g., tdd-UL-DL-ConfigurationDedicated-SN-FU) can be assigned by TDD-UL-DL-ConfigCommon and/or by a new parameter that at least includes subcarrier spacing, for example.

In various implementations, the fifth parameter(s) can include, be, or correspond to MAC CE, UE-specific, and/or group-common DCI. For example, the BS can indicate/provide the fifth TDD UL/DL configuration parameter(s), such as used for SN CU to SN CU. The fifth parameters may be at least one of MAC CE, UE-specific, and/or group-common DCI, such as a certain DCI format. If the fifth parameter is a DCI signaling, the fifth parameter can be scrambled by a new SN specific, link specific, service-type specific, and/or SN logic unit specific RNTI.

In some arrangements, the sixth parameter(s) can be at least one of MAC CE, UE-specific, and/or group-common DCI. For instance, the BS can indicate the sixth TDD UL/DL configuration parameter(s), such as used for SN FU to SN CU, which can be at least one of MAC CE, UE-specific, and/or group-common DCI, such as a certain DCI format or a new DCI. If the sixth parameter is a DCI signaling, the sixth parameter can be scrambled by a new SN specific, link specific, service-type specific, and/or SN logic unit specific RNTI.

In various arrangements, the systems and methods of the technical solution may provide/indicate a single set of TDD/UL/DL configuration parameters for improving the accuracy forwarding control of the SN and flexibility of the SN in network deployment. For example, the BS can indicate one set of TDD UL/DL configuration parameters to the SN (e.g., SN CU). The set of TDD UL/DL configuration parameters can be utilized for SN CU transmission and/or reception. The TDD UL/DL configuration for SN FU transmission and/or reception can be implicitly obtained/indicated/received/determined by the indicated TDD UL/DL configuration of SN CU.

In some aspects, the BS can indicate the (e.g., reference) subcarrier spacing of SN FU to SN CU. The SN CU can split or assemble/combine/aggregate the indicated TDD UL/DL configuration of SN CU according to or based on the subcarrier spacings of CU and/or FU to obtain the TDD UL/DL configuration of SN FU, for example.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a schematic diagram of transmission links between BS to SN and SN to UE, in accordance with some embodiments of the present disclosure;

FIG. 4 illustrates a graph of two frequency ranges associated with respective links, in accordance with some embodiments of the present disclosure; and

FIG. 5 illustrates a flow diagram of an example method for TDD configuration for SN, in accordance with an embodiment of the present disclosure.

### DETAILED DESCRIPTION

### 1. Mobile Communication Technology and Environment

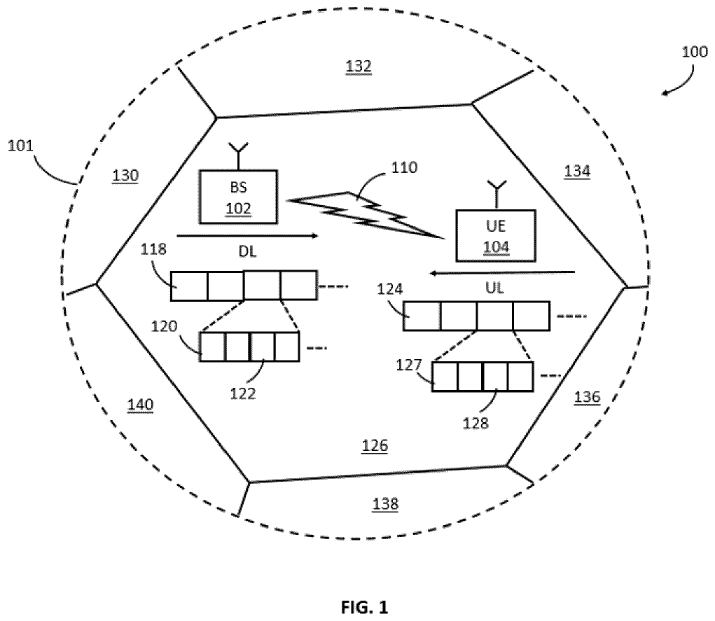

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

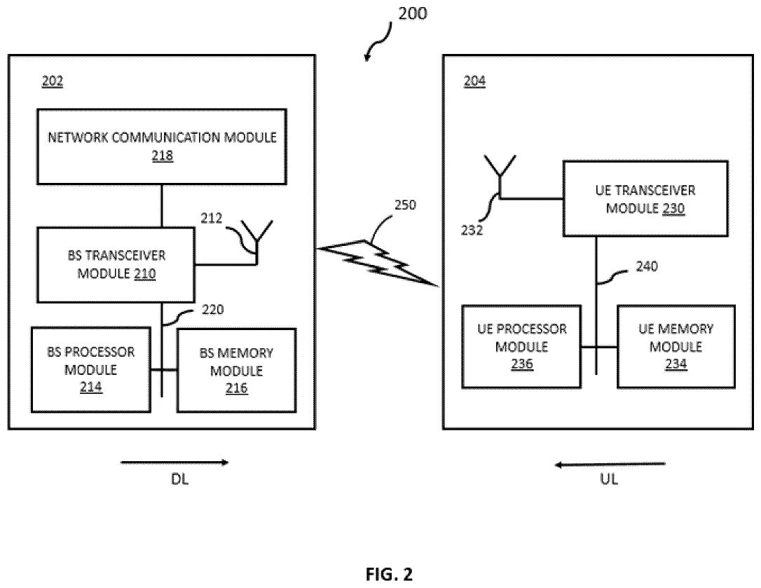

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for TDD Configuration for SNs

In certain systems (e.g., 5G new radio (NR), Next Generation (NG) systems, 3GPP systems, and/or other systems), a network-controlled repeater can be introduced as an enhancement over conventional RF repeaters with the capability to receive and/or process side control information from the network. Side control information can allow a network-controlled repeater to perform/execute/operate its amplify-and-forward operation in a more efficient manner. Certain benefits can include at least mitigation of unnecessary noise amplification, transmissions and receptions with better spatial directivity, and/or simplified network integration.

The network-controlled repeater (NCR) can be regarded as a stepping stone of a re-configurable intelligent surface (RIS). A RIS node can adjust the phase and amplitude of the received signal to improve/enhance the coverage (e.g., network communication coverage). As discussed herein, network nodes, including and not limited to network-controlled repeater, smart repeater, Re-configuration intelligent surface (RIS), Integrated Access and Backhaul (IAB), can be denoted, referred to, or provided as a smart node (SN) (e.g., network node) for simplicity. For example, the SN can include, correspond to, or refer to a kind of network node to assist the BS 102 to improve coverage (e.g., avoiding/averting blockage/obstructions, increasing transmission range, etc.).

However, in certain cases, the frequency band of C-link (e.g., communication/control link or SN CU) may be in a different frequency band from F-link (e.g., forwarding link or SN FU). For instance, the two operating frequency bands may be out-of-band. If C-link and F-link are located out-of-band, the number of DL symbols/slots, UL symbols/slots, flexible symbols/slots, reference subcarrier spacing, and/or periodicity in TDD UL/DL configurations (e.g., among other parameters) of C-link and F-link may be different. Hence, the TDD configurations of C-link and F-link may be different and cannot assumed to be the same.

Further, in some cases, SN FU may include a radio frequency (RF) unit, which by itself cannot detect the signal to obtain its TDD configuration. If SN CU controls SN FU forwarding (e.g., to perform on/off, beam management, and/or power control, etc.) based on the TDD configuration of C-link, the TDD configuration of the C-link can cause resource collision, interference, and/or performance loss as the TDD configuration of C-link may not be the same as TDD configuration for F-link. Therefore, the systems and methods of the technical solution discussed herein provide mechanisms, features, operations, or techniques to obtain/achieve/acquire accurate TDD configuration of F-link (e.g., SN FU), such as to accurately control the forwarding (e.g., forwarding operation or signaling) of SN FU.

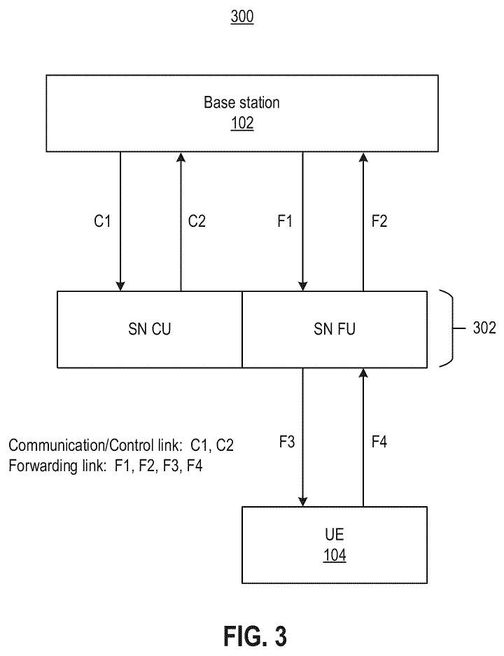

FIG. 3 illustrates a schematic diagram 300 of transmission links between BS 102 to SN 302 and SN 302 to UE 104. The SN 302 can include or consist of at least two functional parts/components/units (e.g., function entities), such as the communication unit (CU) (e.g., SN CU, sometimes referred to as a first function entity or unit)) and the forwarding unit (FU) (e.g., SN FU, sometimes referred to as a second function entity or unit). The function entities can support different functions. For example, the SN CU can be a network-controlled repeater (NCR) MT. In another example, the SN FU can be an NCR forwarder/forwarding (Fwd). The SN CU can act/behave or include features similar to a UE 104, for instance, to receive and decode side control information from the BS 102. The SN CU may be a control unit, controller, mobile terminal (MT), part of a UE, a third-party IoT device, and so on. The SN FU can carry out the intelligent amplify-and-forward operation using the side control information received by the SN CU. The SN FU may be a radio unit (RU), a RIS, and so on. For simplicity, CU (e.g., SN CU) and FU (e.g., SN FU) can correspond to or refer to the first unit and the second unit, respectively.

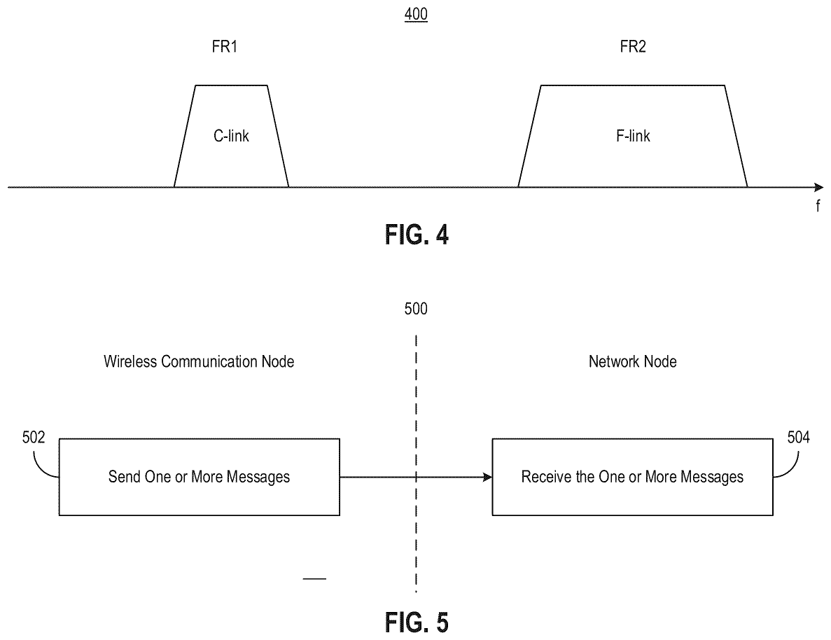

The transmission links between the BS 102 to SN 302 and the SN 302 to UE 104 as shown in FIG. 4 can be defined/described/provided as follows:
C1: Control link (e.g., C-link or first communication link) from SN CU to BS;
C2: Control link (e.g., C-link or second communication link) from BS to SN CU;
F1: Forwarding link (e.g., F-link or first forwarding link, which in this case can be a backhaul link) from SN FU to BS;
F2: (e.g., F-link or second forwarding link, which in this case can be a backhaul link) from BS to SN FU;
F3: (e.g., F-link or third forwarding link, which in this case can be an access link) from UE to SN FU; and
F4: (e.g., F-link or fourth forwarding link, which in this case can be an access link) from SN FU to UE.

Control link (e.g., sometimes referred to as a communication link) can refer to or mean that the signal from one side will be detected and decoded by the other side, so that the information transmitting in the control link can be utilized to control the status of forwarding links (e.g., backhaul links and/or access links). Forwarding link can mean that the signal from BS 102 or UE 104 is unknown to SN FU. In this case, the SN FU can amplify and forward signals without decoding them. For example, the F1 and F3 links can correspond to or be associated with the complete uplink (UL) forwarding link (e.g., backhaul link and access link, respectively) from UE 104 to BS 102, in which F1 is the SN FU UL forwarding link. Additionally, the F2 and F4 links can correspond to or be associated with the complete DL forwarding link (e.g., backhaul link and access link, respectively) from BS 102 to UE 104, in which F4 is the SN FU DL forwarding link. The F1 and F2 links can correspond to or be referred to as backhaul links and F3 and F4 links can correspond to or be referred to as access links.

FIG. 4 illustrates a graph 400 of two frequency ranges associated with respective links. For example, the frequency band of C-link (e.g., SN CU) may be in a different frequency band from F-link (e.g., SN FU), where the two operating frequency bands may be out-of-band. As shown, C-link can work/operate/function in frequency range 1 (FR1) for initial access and/or control the forwarding of F-link. F-link can work in frequency range 2 (FR2) for extension of network coverage. Hence, the two frequency bands can be out-of-band in at least one of the following cases:
The two frequency bands may correspond to different carriers;
The two frequency bands may be located in different frequency bands, such as based on or in accordance with the specification (or initial configuration); and/or
The two frequency bands can be in different frequency ranges (e.g., FR1 and FR2 (e.g., FR2-1 and/or FR2-2)).

For example, if CU controls FU forwarding (e.g., forwarding functionality) based on the TDD configuration of C-link, such as to perform ON/OFF, beam management, and/or power control, resource collision, interference, and/or performance loss may occur as the result of the TDD configuration of C-link being different from the TDD configuration of F-link. Therefore, the systems and methods discussed herein can provide mechanisms/techniques for accurate TDD configuration of F-link for enhanced accuracy of controlling the forwarding (e.g., forwarding operation/functionality) of FU.

In various implementations, C-link for SN CU transmission and/or reception can include at least one of the following links:
A first communication/control link (e.g., C1) from the BS 102 to the SN CU (e.g., of the SN 302); and/or
A second communication link (e.g., C2) from the SN CU to the BS 102.

In various arrangements, F-link used for SN FU transmission and/or reception can include at least one of the following links:
A first forwarding link (e.g., F1) from the BS 102 to the SN FU;
A second forwarding link (e.g., F2) from the SN FU to the BS 102;
A third forwarding link (e.g., F3) from the SN FU to a UE 104; and/or.
A fourth forwarding link (e.g., F4) from the UE 104 to the SN FU.

### Example Implementation 1—Two Sets of TDD UL/DL Configuration Parameters

In various arrangements, the BS 102 can indicate multiple sets (e.g., two sets) of TDD UL/DL configuration parameters to the SN 302 (e.g., SN CU). For instance, the two sets can include a first set of TDD configuration parameters for SN CU transmission/reception and a second set of TDD configuration parameters for SN FU transmission/reception. In this case, the second set can be used/configured for SN CU to control SN FU forwarding.

For example, in addition to indicating a (e.g., first) set of TDD UL/DL configuration parameters used for SN CU to SN CU (e.g., cell-specific and/or dedicated TDD configuration), the BS 102 may indicate another (e.g., second) set of TDD UL/DL configuration parameters used for SN FU to SN CU. For instance, SN CU can use the second set of TDD configuration parameters to control SN FU forwarding, on/off (e.g., enable/disable, true/false, activated/deactivated, etc.) state/condition, beam management, and/or power-control. In various implementations, the set of TDD configuration parameters may refer to a single TDD configuration parameter or a combination of multiple TDD configuration parameters, for example.

In various arrangements, the two sets of TDD configuration parameters indicated/provided/configured/transmitted/sent by the BS 102 to the SN 302 (or SN CU) can include at least one of:
A first set of TDD UL/DL configuration parameters for SN CU can be indicated to SN CU (e.g., configured for a first link). The first set can include at least one of first, third, and/or fifth TDD UL/DL configuration parameters.
A second set of TDD UL/DL configuration parameters for SN FU can be indicated to SN CU (e.g., configured for a second link). The second set can include at least one of second, fourth, and/or sixth TDD UL/DL configuration parameters.

### First TDD UL/DL Configuration Parameters

In some implementations, the BS 102 can indicate at least one first TDD UL/DL configuration parameter(s) used for SN CU to SN CU (e.g., as part of the first set of TDD configuration parameters). The first parameter can be semi-statically configured (e.g., via system information and/or RRC signaling) and/or are common or cell-specific (e.g., for SN FUs and/or UEs in a cell with a first frequency band/carrier). The first parameter can be indicated based on, according to, or via at least one of tdd-UL-DL-ConfigurationCommon in system information block type 1 (SIB1) and/or ServingCellConfigCommon, such as for the TDD configuration used for SN CU. As provided/described in the example TDD-UL-DL-ConfigCommon below, the TDD UL/DL configuration for SN CU can include at least one of reference subcarrier spacing, periodicity, number of DL slots, number of DL symbols, number of UL slots, and/or number of UL symbols, etc.

```
-------------------------------------------------
SIB1->ServingCellConfigCommonSIB->tdd-UL-DL-ConfigurationCommon->TDD-UL-DL-
ConfigCommon, and/or
ServingCellConfigCommon->tdd-UL-DL-ConfigurationCommon->TDD-UL-DL-ConfigCommon
-------------------------------------------------
tdd-UL-DL-ConfigurationCommon TDD-UL-DL-ConfigCommon
OPTIONAL, -- Cond TDD
TDD-UL-DL-ConfigCommon ::= SEQUENCE {
      referenceSubcarrierSpacing SubcarrierSpacing,
      pattern 1 TDD-UL-DL-Pattern,
      pattern 2 TDD-UL-DL-Pattern
}
TDD-UL-DL-Pattern ::= SEQUENCE {
      dl-UL-TransmissionPeriodicity ENUMERATED {ms0p5, ms0p625, ms1,
      ms1p25, ms2, ms2p5, ms5, ms10},
      nrofDownlinkSlots INTEGER (0..maxNrofSlots),
      nrofDownlinkSymbols INTEGER (0..maxNrofSymbols-1),
      nrofUplinkSlots INTEGER (0..maxNrofSlots),
      nrofUplinkSymbols INTEGER (0..maxNrofSymbols-1),
      ...,
}
    Second TDD UL/DL configuration parameters
```

In various implementations, the BS 102 can indicate at least one second TDD UL/DL configuration parameter(s) (e.g., part of the second set of TDD configuration parameters) to SN CU, where the second parameter(s) can be used for SN FU. The second parameter can be semi-statically configured (e.g., via system information and/or RRC signaling) and are common or cell-specific (e.g., for SN FU and/or UE(s) in a cell with a second frequency band/carrier). In some cases, a new parameter can be defined/provided/configured (e.g., in SIB1 and/or ServingCellConfigCommon) for an indication of the TDD UL/DL configuration for SN FU to SN CU. For instance, a new parameter tdd-UL-DL-ConfigurationCommon-SN-FU in SIB1 and/or ServingCellConfigCommon can be defined/provided in the following example:

SIBI -> ServingCellConfigCommonSIB -> tdd-UL-DL-ConfigurationCommon-SN-FU, and/or
ServingCellConfigCommon -> tdd-UL-DL-ConfigurationCommon-SN-FU
-------------------------------------------------

In some implementations, the second TDD UL/DL configuration for SN FU can include at least one of reference subcarrier spacing, periodicity, number of DL slots, number of DL symbols, number of UL slots, and/or number of UL symbols, etc. The new parameter (e.g., tdd-UL-DL-ConfigurationCommon-SN-FU) can be assigned by TDD-UL-DL-ConfigCommon, for example.

In some cases, the (e.g., reference) subcarrier spacing included as part of the second configuration parameter may be limited. In some scenarios, SN CU can be deployed in the low band and SN FU can be deployed in the high band (e.g., relative to the low band), where the subcarrier spacing used by SN FU can be restricted, for example. For example, assuming SN CU works/operatable/functions in FR1 band and SN FU works in FR2 band, the (e.g., reference) subcarrier spacing in the new parameter for FU can be greater than or equal to a certain value, such as 60 kHz or 120 kHz, among others. In other scenarios/cases, the (e.g., reference) subcarrier spacing in the new parameter for FU may be less than a certain value, e.g., 60 kHz or 120 kHz, among others. The value (e.g., the upper limit/bound/threshold or lower limit) can be predetermined/pre-configured in accordance with the specification, the configuration of the BS 102 and/or SN 302, and/or the capability of the SN 302 (e.g., support, compatibility, etc.), among other criteria, for example.

In some implementations, the TDD UL/DL configuration, indicated by, according to, or based on this new parameter for SN FU (e.g., indicated to SN CU) in the first frequency band/carrier (e.g., SN CU working frequency band/carrier, such as in FR1), can include, correspond to, or be at least one of the following:
Similar to TDD UL/DL configuration of the BS 102 (e.g., gNB or wireless communication node) indicating to one or more UEs 104 in a second frequency band/carrier (e.g., SN FU working frequency band/carrier, such as in FR2);
Similar to TDD UL/DL configuration of BS 102 indicating through/via SIB1 and/or ServingCellConfigCommon to one or more UEs 104 in the second frequency band/carrier; and/or
A combination of common configuration and dedicated configuration of BS 102 indicating to one or more UEs 104 in the second frequency band/carrier.

### Third TDD UL/DL Configuration Parameters

The BS 102 can indicate at least one third TDD UL/DL configuration parameter(s) to SN CU, used for SN CU (e.g., as part of the first set of TDD UL/DL configuration parameters). The third parameter(s) can be semi-statically configured (e.g., via RRC signaling) and may be dedicated (e.g., equipment-dedicated, link-dedicated, and/or SN-dedicated, etc.), UE-specific, or SN-specific, such as for controlling reception and/or transmission over the respective link (e.g., the first link in this case).

In some implementations, the parameter tdd-UL-DL-ConfigurationDedicated in ServingCellConfig can be used for indicating the TDD UL/DL configuration used for SN CU to SN CU. The TDD UL/DL configuration used for SN CU can include at least oen of slot index, number of DL symbols, and/or number of UL symbols, etc., which can be provided/indicated in the TDD-UL-DL-ConfigDedicated, an example of which can be provided as follows.

```
-------------------------------------------------
ServingCellConfig -> tdd-UL-DL-ConfigurationDedicated
-------------------------------------------------
ServingCellConfig ::= SEQUENCE {
    tdd-UL-DL-ConfigurationDedicated TDD-UL-DL-ConfigDedicated
OPTIONAL, -- Cond TDD
TDD-UL-DL-ConfigDedicated ::= SEQUENCE {
    slotSpecificConfigurationsToAddModList SEQUENCE (SIZE (1..maxNrofSlots)) OF
    TDD-UL-DL-SlotConfig OPTIONAL, -- Need N
    slotSpecificConfigurationsToReleaseList SEQUENCE (SIZE (1..maxNrofSlots)) OF
    TDD-UL-DL-SlotIndex OPTIONAL, -- Need N
    ...
}
...
TDD-UL-DL-SlotConfig ::= SEQUENCE {
    slotIndex TDD-UL-DL-SlotIndex,
    symbols CHOICE {
          allDownlink NULL,
          allUplink NULL,
          explicit SEQUENCE {
                      nrofDownlinkSymbols INTEGER
                      (1..maxNrofSymbols-1)
                      nrofUplinkSymbols INTEGER
                      (1..maxNrofSymbols-1)
        }
    }
}
...
TDD-UL-DL-SlotIndex ::= INTEGER (0..maxNrofSlots-1)
  Fourth TDD UL/DL configuration parameters
```

In various arrangements, the BS 102 can indicate at least one fourth TDD UL/DL configuration parameter(s) used for SN FU to SN CU (e.g., as part of the second set of TDD UL/DL configuration parameters). The fourth parameter(s) can be semi-statically configured (e.g., via RRC signaling) and may be dedicated (e.g., equipment-dedicated, link-dedicated, SN-dedicated, etc.), UE-specific, and/or SN-specific. In some cases, a new parameter can be defined/configued (e.g., in ServingCellConfig) to be used for the indication of TDD UL/DL configuration used for SN FU to SN CU. For instance, tdd-UL-DL-ConfigurationDediated-SN-FU can be configured as the new parameter (e.g., defined in ServingCellConfig), an example of which is provided as follows:

### ServingCellConfig->tdd-UL-DL-ConfigurationDedicated-SN-FU

In some implementations, one or more arrangements (e.g., implementations, options, cases, alternatives, configurations, etc.) of the fourth TDD UL/DL configuration parameters can be considered. For example, the fourth TDD UL/DL configuration parameters can be configured as follows:

### Fourth TDD UL/DL Configuration Parameters—Arrangement 1:

In some implementations, the new parameter (e.g., tdd-UL-DL-ConfigurationDedicated-SN-FU) can be assigned by TDD-UL-DL-ConfigDedicated. The TDD-UL-DL-ConfigDedicated can be similar to the currently/initially defined parameter TDD-UL-DL-ConfigDedicated in the specification (e.g., including similar elements, description, and/or features, etc.) or can include at least one enhanced parameter, such as including subcarrier spacing, among others. An example of the new parameter can be shown as follows:

```
ServingCellConfig ::= SEQUENCE {
      ...
      tdd-UL-DL-ConfigurationDedicated-SN-FU TDD-UL-DL-ConfigDedicated
OPTIONAL,  -- Cond TDD
          Fourth TDD UL/DL configuration parameters - Arrangement 2:
```

In some cases, the new parameter (e.g., tdd-UL-DL-ConfigurationDedicated-SN-FU) can be assigned by TDD-UL-DL-ConfigCommon and/or by a new parameter, such as including at least subcarrier spacing, among others. An example of the new parameter in this case can be shown as follows:

ServingCellConfig ::= SEQUENCE {
tdd-UL-DL-ConfigurationDedicated-SN-FU TDD-UL-DL-ConfigCommon
OPTIONAL, -- Cond TDD

### Fifth TDD UL/DL Configuration Parameters

In some arrangements, the BS 102 can indicate/provide at least one fifth of TDD UL/DL configuration parameter(s) used for SN CU to SN CU (e.g., as part of the first set of TDD UL/DL configuration parameters). The fifth parameter(s) can include or indicate at least one of MAC CE, UE-specific, and/or group-common DCI (e.g., a certain predefined DCI format), among others.

### Sixth TDD UL/DL Configuration Parameters

The BS 102 can indicate at least one sixth of TDD UL/DL configuration parameter(s) used for SN FU to SN CU (e.g., as part of the second set of TDD UL/DL configuration parameters). The sixth parameter(s) can include, correspond to, or indicate at least one of MAC CE, UE-specific, and/or group-common DCI (e.g., a certain predefined DCI format and/or a new DCI). In various arrangements, at least one of the two sets of TDD UL/DL configuration parameters can include additional TDD UL/DL configuration parameters, such as seventh, eight, and/or ninth TDD UL/DL configuration parameters, etc., for example.

As described herein, some examples, among other examples in addition to these examples, of the two sets of TDD configuration parameters (e.g., indicated/provided by the BS 102 to the SN 302 (or SN CU)) can include the following combinations of the TDD UL/DL configuration parameters as part of the two sets:

### Example 1 for Two Sets of TDD Configuration Parameters

In some implementations, the first set of TDD UL/DL configuration parameters used for SN CU to SN CU can include the first TDD UL/DL configuration parameter(s). The second set of TDD UL/DL configuration parameters used for SN FU to SN CU can include the second TDD UL/DL configuration parameter(s).

### Example 2 for Two Sets of TDD Configuration Parameters

In some implementations, the first set of TDD UL/DL configuration parameters can include the first TDD UL/DL configuration parameter(s). The second set of TDD UL/DL configuration parameters can include the second and fourth TDD UL/DL configuration parameters.

### Example 3 for Two Sets of TDD Configuration Parameters

In some implementations, the first set of TDD UL/DL configuration parameters can include the first and third TDD UL/DL configuration parameters. The second set of TDD UL/DL configuration parameters can include the second TDD UL/DL configuration parameters.

### Example 4 for Two Sets of TDD Configuration Parameters

In some implementations, the first set of TDD UL/DL configuration parameters can include the first and third TDD UL/DL configuration parameters. The second set of TDD UL/DL configuration parameters can include the second and fourth TDD UL/DL configuration parameters.

### Example 5 for Two Sets of TDD Configuration Parameters

The first set of TDD UL/DL configuration parameters can include the first TDD UL/DL configuration parameters. The second set of TDD UL/DL configuration parameters can include the fourth TDD UL/DL configuration parameters.

### Example 6 for Two Sets of TDD Configuration Parameters

The first set of TDD UL/DL configuration parameters can include first and third TDD UL/DL configuration parameters. The second set of TDD UL/DL configuration parameters can include fourth TDD UL/DL configuration parameters.

### Example 7 for Two Sets of TDD Configuration Parameters

The first set of TDD UL/DL configuration parameters can include the first, third, and fifth TDD UL/DL configuration parameters. The second set of TDD UL/DL configuration parameters can include the second, fourth, and sixth TDD UL/DL configuration parameters.

Other combinations of the TDD UL/DL configuration parameters included as part fo the two sets of TDD UL/DL configuration parameters can also be used or indicated for the SN 302 (e.g., SN CU). For instance, any one or combination of the first, third, and/or fifth TDD UL/DL configuration parameters can be included as part of the first set, and any one or combination of the second, fourth, and/or sixth TDD UL/DL configuration parameters can be included as part of the second set. Upon/in response to the SN CU (e.g., first unit) receiving the sets of TDD UL/DL configuration parameters, at least one of SN CU and/or SN FU can control or perform reception and/or transmission over the respective link, such as in accordance with the TDD UL/DL configuration parameters discussed herein.

### Example Implementation 2—One Set of TDD UL/DL Configuration Parameters

In various implementations, the BS 102 may indicate one set of TDD UL/DL configuration parameters to the SN 302 (e.g., SN CU). For example, the set of TDD UL/DL configuration parameters can indicate/provide TDD UL/DL configuration used for SN CU transmission/reception. Further, the set of TDD UL/DL configuration parameters can implicitly indicate the TDD UL/DL configuration for SN FU transmission/reception (e.g., implicitly obtained/acquired/received by the SN CU).

In some implementations, the one set of TDD UL/DL configuration parameters can include or correspond to a single configuration parameter or a combination of multiple configuration parameters. For example, the one set of TDD UL/DL configuration parameters can include system information (e.g., a parameter in SIB1), an RRC signaling, a MAC CE, and/or a DCI signaling, among others.

In various arrangements, the BS 102 can indicate the (e.g., reference) subcarrier spacing of SN FU to SN CU. SN CU may split/divide or assemble/aggregate the indicated TDD UL/DL configuration of SN CU according to the subcarrier spacings of CU and FU, such as to obtain at least one TDD UL/DL configuration of SN FU. For example, the reference subcarrier spacing of CU in FR1 can be a first predefined/predetermined/pre-configured frequency, such as 30 kHz, etc., and the reference subcarrier spacing of FU in FR2 can be a second predefined frequency, such as 120 kHz, etc. In this case, one DL/UL slot/symbol in the TDD UL/DL configuration of CU can be split into four DL/UL slots/symbols in the TDD UL/DL configuration of FU, for example.

In some cases, the TDD UL/DL configuration indicated by the BS 102 to the one or more UEs 104 in the FR2 (e.g., the frequency band of FU and UE(s) 104) can be different from (e.g., not an exact match of) the TDD UL/DL configuration indicated by the BS 102 to CU in the FR1 (e.g., the frequency band of CU). For instance, the TDD UL/DL configuration of FU obtained by the split of the TDD UL/DL configuration of CU may not be consistent with the actual/real TDD UL/DL configuration of FU indicated by the BS 102 to the UE(s) 104. In this case, and to match the TDD UL/DL configuration indicated by the BS 102 to the UE(s) 104 and the TDD UL/DL configuration indicated by the BS 102 to CU, the two configurations may be scaled based on one or more parameters indicated in the set of TDD UL/DL configuration parameters (e.g., according to their subcarrier spacing), for example.

For example, the reference subcarrier spacing of CU in FR1 may be 30 kHz, and the reference subcarrier spacing of FU in FR2 may be 60 kHz. In this example, the TDD UL/DL configuration of CU can be DDDFU. The TDD UL/DL configuration indicated by the BS 102 to the UE(s) 104 can be DDDDDDFFUU (e.g., power of two, or in this case, multiple of two). Subsequently, the CU can split the indicated TDD UL/DL configuration of CU to obtain/acquire/determine TDD UL/DL configuration of FU, which can be the same as TDD UL/DL configuration indicated by the BS 102 to the UE(s) 104. In some cases, if the TDD UL/DL configuration indicated by the BS 102 to the UE(s) 104 is DDDDDDFFFU (e.g., representing 10 slots, where “D” represents/corresponds to downlink slots, the “U” represents an uplink slot, and the “F” represents flexible slots, which can include flexible symbols), for instance, then CU may not obtain the TDD UL/DL configuration of FU from splitting the indicated TDD UL/DL configuration of CU. The configuration of the slots can be configured by the BS 102 to the UE(s) 104.

### Example Implementation 3-Out-of-Band C-Link and F-Link

In various arrangements, for C-link (e.g., first link) and F-link (e.g., second link) located in the out-of-band, two links may share the same RF, or in some cases, there may be leakage between the two links (e.g., from one link to another, or between both links, which may not share the same RF). In some implementations, if C-link and F-link are configured with different TDD patterns (e.g., directions), such as in the same symbol/slot, the C-link at the SN 302 can be configured as the DL (e.g., C1 link), and the F-link at the SN 302 can be configured as the UL (e.g., at least one of F2 link and/or F4 link). In the symbol/slot, the SN 302 may select at least one of the links or directions to transmit and/or receive data (e.g., from the BS 102 or the UE 104).

For example, if the C-link (or CU) and the F-link (or FU) at the SN 302 are configured with different TDD patterns or directions in a symbol/slot, then at least one of the following example scenarios can occur:
The SN 302 can perform/execute/initiate C-link transmission and/or reception (e.g., over the first link), and/or the SN 302 can stop/terminate F-link forwarding (e.g., transmission and/or reception over the second link). For instance, the SN 302 may not be expected to forward the data (e.g., channels/signals) over the second link. In this case, high priority may be given/assigned/provided to the sending and/or receiving control information in the C-link (e.g., first link).
The SN 302 can perform F-link forwarding (e.g., transmission and/or reception over the second link), and/or the SN 302 can stop C-link transmission and/or reception. For instance, the SN 302 may not be expected to transmit and/or receive the data (e.g., channels/signals) over the first link. In this case, high priority may be given to the forwarding the data from the BS 102 and/or the UE 104 for coverage between the entities.
The SN 302 can perform UL operation and/or stop DL operation. For example, if C-link at the SN 320 is configured as DL (e.g., C1 link), and F-link at the SN 302 is configured as UL (e.g., F2 link and/or F4 link), in the symbol/slot, the SN 302 can execute F-link forwarding (e.g., from the UE(s) 104 to the BS 102) and stop C-link reception (e.g., from the BS 102). In another example, if C-link at the SN 302 is configured as UL (e.g., C2 link), and F-link at the SN 302 is configured as DL (e.g., F1 link and/or F3 link), in the symbol/slot, the SN 302 can execute C-link transmission (e.g., to the BS 102) and stop F-link forwarding (e.g., from the BS 102 to the UE(s) 104). For instance, the SN 302 may not be expected to transmit and/or receive the data (e.g., channels/signals) over the downlink.
The SN 302 can perform DL operation and/or stop UL operation. For example, if C-link at the SN 302 is configured as DL (e.g., C1 link), and F-link at the SN 302 is configured as UL (e.g., F2 link and/or F4 link), in the symbol/slot, the SN 302 can perform C-link reception and stop F-link forwarding. In another example, if C-link at the SN 302 is configured as UL (e.g., C2 link), and F-link at the SN 302 is configured as DL (e.g., F1 link and/or F3 link), in the symbol/slot, the SN 302 can perform F-link forwarding and stop C-link transmission. For instance, the SN 302 may not be expected to transmit and/or receive the data (e.g., channels/signals) over the uplink.
High priority link(s) and/or direction(s) can be configured by the BS 102 and/or OAM to the SN 302 through system information, RRC signaling, MAC CE, and/or DCI, among other types of signaling, for example.

Referring now to FIG. 5, depicted is a flow diagram of a method 500 for TDD configuration for SN. The method 500 may be implemented using any of the components and devices detailed herein in conjunction with FIGS. 1-4. In overview, the method 500 may include sending one or more messages (502). The method 500 may include receiving the one or more messages (504).

Referring now to operation (502), and in some implementations, a wireless communication node (e.g., BS or gNB) can send/transmit/provide/signal one or more messages to a network node (e.g., SN). The one or more messages can indicate or include indications of a first set of TDD configuration parameters (e.g., TDD UL/DL configuration parameters) and a second set of TDD configuration parameters. The first set of TDD configuration parameters can be configured for a first link (e.g., control/communication link or C-link). The second set of TDD configuration parameters can be configured for a second link (e.g., forwarding link or F-link). Referring now to operation (504), after the transmission by the wireless communication node, the network node can receive the one or more messages.

In various implementations, the first link can include at least one of the following links: a first communication link (e.g., C1 link) from the wireless communication node to the network node; and/or a second communication link (e.g., C2 link) from the network node to the wireless communication node. In various arrangements, the second link can include at least one of the following links: a first forwarding link (e.g., F1 link) from the wireless communication node to the network node; a second forwarding link (e.g., F2 link) from the network node to the wireless communication node; a third forwarding link (e.g., F3 link) from the network node to a wireless communication device (e.g., UE); or a fourth forwarding link (e.g., F4 link) from the wireless communication device to the network node.

In various implementations, the first link can work/operate/function in or may be configured with a first frequency band or carrier (e.g., FR1). The second link can work in or may be configured with a second frequency band or carrier (e.g., FR2).

In various aspects, the network node can include a first unit (e.g., SN CU) and a second unit (e.g., SN FU). The two units of the network node can include or perform different functionalities. In some cases, the TDD configuration parameters may be used by SN CU and/or SN FU. For example, in response to the first unit receiving the first set of TDD configuration parameters, the first unit can control the reception and/or transmission (e.g., of data/information) over the first link (e.g., at least one of the first communication link or the second communication link). In another example, in response to the first unit receiving the second set of TDD configuration parameters, the second unit may perform reception and/or transmission over the second link. In some cases (e.g., additionally or alternatively), in response to the first unit receiving the second set of TDD configuration parameters, the first unit can forward the second set of TDD configuration parameters to the second unit, such as to allow the second unit to control reception and/or transmission over the second link (e.g., at least one of the first, second, third, or fourth forwarding link).

In some implementations, if the first link and the second link are configured with different TDD patterns and/or different directions in a symbol/slot, the network node can perform/execute/operate at least one of the following. For example, the network node can perform transmission and/or reception over the first link, and stop forwarding over the second link. In another example, the network node can perform forwarding over the second link, and stop transmission and/or reception over the first link. In further example, the network node may perform an uplink operation (e.g., transmission and/or reception over F2 link and F4 link), and stop downlink operation (e.g., stop transmission and/or reception over F1 and F3 link). In yet another example, the network node can perform downlink operation (e.g., transmission and/or reception over F1 link and F3 link), and stop UL operation (e.g., transmission and/or reception over F2 link and F4 link). In some cases, a high priority link and/or direction can be configured by the wireless communication node and/or an operations, administration, and maintenance (OAM) node to the network node through system information, RRC signaling, MAC CE, and/or DCI, among others.

In various arrangements, the first set of TDD configuration parameters and the second set of TDD configuration parameters can respectively include various (e.g., numerous) parameters. For example, the first set of TDD configuration parameters can include a first parameter that is commonly, cell-specifically, and/or semi-statically configured for controlling reception and/or transmission over the first link. The one or more messages can each be an RRC signaling or system information (SI). The first set of TDD configuration parameters can include a third parameter that is equipment-dedicatedly, equipment-specifically, and/or semi-statically configured for controlling reception and/or transmission over the first link. The first set of TDD configuration parameters can include a fifth parameter that is a MAC CE and/or a DCI, among others.

In another example, the second set of TDD configuration parameters can include a second parameter that is commonly, cell-specifically, and/or semi-statically configured for controlling reception and/or transmission over the second link. The one or more messages can each be an RRC signaling or SI. The second set of TDD configuration parameters can include a fourth parameter that is equipment-dedicatedly, equipment-specifically, and/or semi-statically configured for controlling reception and/or transmission over the second link. The second set of TDD configuration parameters can include a sixth parameter that is a MAC CE, and/or a DCI, among others.

In various arrangements, the network node may receive one or more messages from the wireless communication node that indicates a single set of TDD configuration parameters. The single set of TDD configuration parameters can be configured for a first link and implicitly for a second link, for example. In some implementations, the first link can include at least one of the first communication link from the wireless communication node to the network node, and/or a second communication link from the network node to the wireless communication node. The second link can include at least one of a first forwarding link from the wireless communication node to the network node, a second forwarding link from the network node to the wireless communication node, a third forwarding link from the network node to a wireless communication device, and/or a fourth forwarding link from the wireless communication device to the network node, for example.

In some implementations, the network node can include a first unit and a second unit. For example, in response to, after, or subsequent to the first unit receiving the single set of TDD configuration parameters, the first unit can control the reception and/or transmission over the first link. In further example, in response to the first unit receiving a subcarrier spacing associated with the second unit, the first unit can determine a set of TDD configuration parameters based on the subcarrier spacing, such as configured to control reception and/or transmission over the second link.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A wireless communication method, comprising:
receiving, by a network node from a wireless communication node, one or more messages indicating a first set of Time Division Duplex (TDD) configuration parameters and a second set of TDD configuration parameters;
wherein the first set of TDD configuration parameters are configured for a first link; and
wherein the second set of TDD configuration parameters are configured for a second link.

2. The wireless communication method of claim 1, wherein the first link comprises at least one of following links:
a first communication link from the wireless communication node to the network node; or
a second communication link from the network node to the wireless communication node.

3. The wireless communication method of claim 1, wherein the second link comprises at least one of following links:
a first forwarding link from the wireless communication node to the network node;
a second forwarding link from the network node to the wireless communication node;
a third forwarding link from the network node to a wireless communication device; or
a fourth forwarding link from the wireless communication device to the network node.

4. The wireless communication method of claim 1, wherein the first link works in or is configured with a first frequency band or carrier, and wherein the second link works in or is configured with a second frequency band or carrier.

5. The wireless communication method of claim 1, wherein the network node includes a first unit and a second unit, the method further comprises:
in response to the first unit receiving the first set of TDD configuration parameters, controlling, by the first unit, reception and/or transmission over the first link; and
in response to the first unit receiving the second set of TDD configuration parameters, performing, by the second unit, reception and/or transmission over the second link, or forwarding, by the first unit to the second unit, the second set of TDD configuration parameters to allow the second unit to control reception and/or transmission over the second link.

6. The wireless communication method of claim 1, wherein if the first link and the second link are configured with different TDD patterns or different directions in a symbol or slot, the wireless communication method comprises:
performing, by the network node, transmission or reception over the first link, and stopping, by the network node, forwarding over the second link;
performing, by the network node, forwarding over the second link, and stopping, by the network node, transmission or reception over the first link;
performing, by the network node, uplink operation and stopping, by the network node, downlink operation; or
performing, by the network node, downlink operation and stopping, by the network node, UL operation;
wherein a high priority link or direction is configured by the wireless communication node or an Operations, Administration, and Maintenance (OAM) node to the network node through system information, radio resource control (RRC) signaling, medium access control control element (MAC CE), or downlink control information (DCI).

7. The wireless communication method of claim 1, wherein the first set of TDD configuration parameters includes a first parameter that is commonly, cell-specifically, or semi-statically for controlling reception and/or transmission over the first link.

8. The wireless communication method of claim 1, wherein the second set of TDD configuration parameters includes a second parameter that is commonly, cell-specifically, or semi-statically for controlling reception and/or transmission over the second link.

9. The wireless communication method of claim 1, wherein the first set of TDD configuration parameters includes a third parameter that is equipment-dedicatedly, equipment-specifically or semi-statically for controlling reception and/or transmission over the first link.

10. The wireless communication method of claim 1, wherein the second set of TDD configuration parameters includes a fourth parameter that is equipment-dedicatedly, equipment-specifically or semi-statically for controlling reception and/or transmission over the second link.

11. The wireless communication method of claim 7, wherein the one or more messages are each a Radio Resource Control (RRC) signaling or System Information (SI).

12. The wireless communication method of claim 1, wherein the first set of TDD configuration parameters includes a fifth parameter that is a Medium Access Control Control Element (MAC CE), or a downlink control information (DCI.).

13. The wireless communication method of claim 1, wherein the second set of TDD configuration parameters includes a sixth parameter that is a medium access control control element (MAC CE), or a downlink control information (DCI).

14. A wireless communication method, comprising:
sending, a wireless communication node to a network node, one or more messages indicating a first set of Time Division Duplex (TDD) configuration parameters and a second set of TDD configuration parameters;
wherein the first set of TDD configuration parameters are configured for a first link; and
wherein the second set of TDD configuration parameters are configured for a second link.

15. A wireless communication node, comprising:
at least one processor configured to:
send, via a transmitter to a network node, one or more messages indicating a first set of Time Division Duplex (TDD) configuration parameters and a second set of TDD configuration parameters;
wherein the first set of TDD configuration parameters are configured for a first link; and
wherein the second set of TDD configuration parameters are configured for a second link.

16. A network node, comprising:
at least one processor configured to:
receive, via a receiver from a wireless communication node, one or more messages indicating a first set of Time Division Duplex (TDD) configuration parameters and a second set of TDD configuration parameters;
wherein the first set of TDD configuration parameters are configured for a first link; and
wherein the second set of TDD configuration parameters are configured for a second link.

17. The network node of claim 16, wherein the first link comprises at least one of following links:
a first communication link from the wireless communication node to the network node; or
a second communication link from the network node to the wireless communication node.

18. The network node of claim 16, wherein the second link comprises at least one of following links:
a first forwarding link from the wireless communication node to the network node;
a second forwarding link from the network node to the wireless communication node;
a third forwarding link from the network node to a wireless communication device; or
a fourth forwarding link from the wireless communication device to the network node.

19. The network node of claim 16, wherein the first link works in or is configured with a first frequency band or carrier, and wherein the second link works in or is configured with a second frequency band or carrier.

20. The network node of claim 16, wherein the network node includes a first unit and a second unit, the method further comprises:
in response to the first unit receiving the first set of TDD configuration parameters, controlling, by the first unit, reception and/or transmission over the first link; and
in response to the first unit receiving the second set of TDD configuration parameters, performing, by the second unit, reception and/or transmission over the second link, or forwarding, by the first unit to the second unit, the second set of TDD configuration parameters to allow the second unit to control reception and/or transmission over the second link.
